(19) United States
(12) Patent Application Publication
(10) Pub. No.: US 2003/0149507 A1
(43) Pub. Date: Aug. 7, 2003

(54) Method and installation for laser engraving of chalcografic plates or cylinders

(75) Inventor: Edoardo Pierozzi, Cagli (IT)

Correspondence Address: ARMSTRONG, WESTERMAN & HATTORI, LLP, 502 Washington Avenue, Suite 220, Towson, MD, 21204, US

(73) Assignee: TECH EPIKOS - S.R.L.

(21) Appl. No.: 10/132,127

(22) Filed: Apr. 24, 2002

(30) Foreign Application Priority Data
Feb. 6, 2002 (IT) MC2002A000011

(51) Int. Cl. G06F 19/00

(52) U.S. Cl. 700/166

(57) ABSTRACT

The present invention relates to a method used to engrave chalcographic plates or cylinders, characterised by the fact that plates and cylinders are engraved by means of a laser beam generated by a pulsed laser device with resonance chamber housing a silicon bar with 50 mm length and 4 mm diameter with NewDimium 0.8% doping and convex mirror with 500-mm radius.

The present patent application for industrial invention relates to a method used to engrave chalcographic plates or cylinders with laser technology, together with the relevant installation.

As it is known, chalcography requires engraving the drawing to be printed on a plate or a cylinder, according to the type of machine used. It is also known that the deeper the engraving is on the plate, the more evident the tactile relief on the printed product will be.

Today chalcolgraphic plates are engraved by means of two different processes, both starting from brass, nickel and steel plates, which are known respectively as “photomechanics” and “chemical-galvanoplastics”.

The first of these traditional processes includes the following operating phases:

Photosensitization of the plate with a suitable polymerising solution

Exposure of the plate at the light emitted by a powerful U.V.A. lamp thanks to the superimposition of a previously generated film

Development of the plate to remove the material that was not exposed to the lamp

Immersion of the plate in a iron perchloride engraving bath

Immersion of the plate in a chromium-plating bath to guarantee longer duration.

The second of these traditional processes includes the following sequence of operating phases:

Surface engraving, of manual type or by means of photochemical and/or mechanical systems, of a plate of ductile ferrous material in order to obtain a negative matrix.

Creation of a positive matrix on metal or plastic material that cannot be attacked by acids, by means of contact and pressure on the negative matrix.

Duplication of the positive matrix in the number of items that can be mounted on a suitable frame

Immersion of the frame in a galvanic bath containing a solution of the material that will form the final plate with multiple matrixes, normally nickel.

Although they have been used with good results for a very long time, these two traditional processes show some inconveniences related to the need of optimising the plates with corrective actions during the process on one side and to the impossibility of realising a “series” production of perfectly identical printing plates on the other side.

Because of the intrinsic nature of the two processes, plates often show small differences in the engraving depth that are reflected in printed products.

Apart from the above, two important drawbacks of the traditional processes must be mentioned.

First of all, these processes involve significant environmental problems because they use highly toxic and polluting chemical products requiring special attention and precautions both during use and disposal, the latter being very expensive and governed by regulations and laws.

Moreover, these two traditional processes are significantly impaired by a natural tendency to unstable results; since they make use of chemical products, these processes are significantly affected by environmental factors.

Simple variations in temperature and/or air humidity rate can impair the final outcome of the entire process; in particular temperature increase can accelerate chemical reactions, thus reducing their duration and impairing the validity of the final results.

The method of the invention, which is basically based on the use of laser technology, has been devised after a close examination of the traditional processes and their aforementioned disadvantages,

The new method ensures the perfectly identical reproduction of more copies of each plate or cylinder; when correctly set, it results in excellent engraving of plates or cylinders without the need of corrective actions.

The method of the invention is extremely advantageous also from the environmental viewpoint, since it makes no use of chemical agents. At the same time, it is not affected by the environmental factors that may be critical for chemistry-based processes.

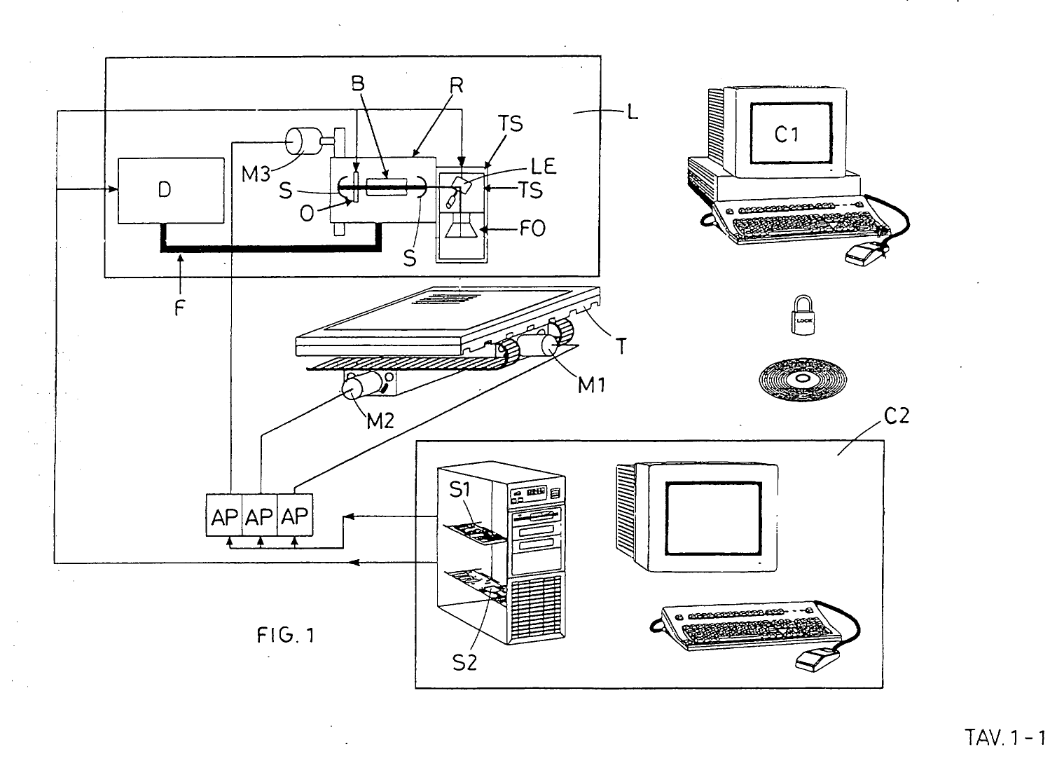

For major clarity the description of the invention continues with reference to the enclosed drawings, which are intended for purposes of illustration and not in a limiting sense, whereby FIG. 1 is the block diagram of the installation using the method of the invention.

With reference to FIG. 1, the engraving method of the invention is based on the use of a laser device (L), while chalcographic drawings are obtained with computer graphics software.

The image is saved in a first computer (C1) where the file is processed with ordinary technologies in order to obtain a format with punctual information and final dimensions of the image. Based on known technologies, punctual information is converted into vector information to send it to a second computer (C2) that processes it in order to manage the installation used to engrave plates with a laser beam.

It must be said that data generated by the graphic station (C1) are encrypted with asymmetrical key through public and private signature, in order to prevent their use by laser-control stations other than the station (C2) that contains the key used to decode the data of the first station (C1).

According to the method of the invention, each plate to be engraved with laser is fixed on a platform (T) capable of sliding on guides according to two Cartesian axes and actuated by step by step motors (M1, M2) controlled by the same computer (C2) in which the engraving files are loaded, which is also responsible for actuating the laser device (L).

In particular, the guides are controlled by means of a first electronic board (S1) capable of resetting the axes through optical trace and verifying the height of the head of the laser device (L) for the correct focusing on the plate to be engraved.

It must be noted that the board (S1) controls the motor (M3) designed to raise or lower the head of the laser device (L).

In view of the fact that the output power of the board (S1) is not sufficient to drive the step by step motors (M1, M2, M3), the signals coming from the board (S1) are sent to a group of power actuators (AP), one for each motor, powered by an internal circuit that generates a signal with suitable power to drive the step by step motors with permanent magnets.

The same computer (C2) houses a second electronic board (S2) used to control and drive the components of the head of the laser device (L).

More precisely, the board (S2) manages the head of a scanner (TS), a pumping diode (D) and an optometric shutter (O); the pumping diode (D) is external to the resonance chamber (R) to which it is connected by means of optical fibre (F).

In particular, the implementation of the method of the invention is made possible by the innovative configuration of the laser device used, of so-called “pulsed” type that uses an optoelectronic shutter (O) that, by closing at regular intervals, generates pulses whose power is largely higher than the power of an ordinary continues laser device (that is a laser device where the shutter is always open).

The laser device of the invention allows for choosing the opening frequency of the shutter, thus selecting the energy of the laser pulse emitted by the device from time to time according to the specific requirements of the engraving.

The quality and precision of the engraving according to the method of the invention depend on the configuration of the resonance chamber (R) of the laser device (L); the resonance chamber uses a silicon bar (B) with 50-mm length and 4-mm diameter with NewDimium 0,8% doping and convex mirror (S) with 500-mm radius.

The values of the parameters of the laser device have been defined based on these characteristics in order to optimise engraving time according to the complexity and dimensions of the drawings to be engraved on the plate surface.

The parameters are as follows:

Ratio between speed (expressed in mm./sec) and frequency (expressed in Khz) ranging from 0.9 to 2.1, where speed indicates the movement speed of the laser trace and frequency indicates the frequency of the alternate operating phases of the shutter (O);

Power of the pumping diode (D) ranging from 9 and 10 Watt;

Pulse duration of 2 nsec.

According to the installation of the invention the pumping diode (D) illuminates a NewDimiumYag bar that generates a laser beam.

The laser beam is guided by means of two highly reflecting lenses (LE) moved by two galvanometric motors that guide the beam on the focal lens (FO) that concentrates it on the desired point.

The lens focus determines the area of the engraving; a preferred embodiment of the invention uses lenses with focuses ranging from 60 to 160 mm., which correspond to useful engraving areas of 30×30 and 100×100 mm.

In order to avoid that the focal lens is reached by the fumes generated when the material is engraved, a fume aspiration system is provided near the lens, formed by a fan connected by means of a duct to a hood made of a suitable material capable of absorbing the wavelength of the laser beam in order to protect the visual system of the operator.

1) A method used to engrave chalcographic plates or cylinders characterised by the fact that plates and cylinders are engraved by means of a laser beam generated by a pulsed laser device (L) with resonance chamber (R) housing a silicon bar (B) with 50-mm length and 4-mm diameter, with NewDimium 0.8% doping and convex mirror (S) with 500-mm radius.

2) A method according to claim 1 characterised by the fact that the laser engraving is carried out based on the following parameters:
Ratio between speed (expressed in mm./sec) and frequency (expressed in Khz) ranging from 0.9 to 2.1, where speed indicates the movement speed of the laser trace and frequency indicates the frequency of the alternate operating phases of the shutter (O);
Power of the pumping diode (D) ranging from 9 and 10 Watt;
Pulse duration of 2 nsec.

3) A method according to claim 1 characterised by the fact that engraving is carried out by moving the plate (or cylinder) to be engraved according to two orthogonal axes and by moving the head (TS) of the laser device (L) according to an orthogonal axis to the plane defined by the two movement axes of the plate (or cylinder).

4) A method according to claim 1 characterised by the fact that the movement of the laser device (L) and the plate (or cylinder) to be engraved is entrusted to two electronic boards (S1, S2) that are an integral part of a computer (C2) used to reprocess the chalcographic drawings sent with vector information by another computer (C1) by means of encrypted connection.

5) Installation for the engraving of chalcographic plates or cylinders, characterised by the fact that it includes:
A pulsed laser device (L) with resonance chamber (R) housing a silicon bar (B) with 50-mm length and 4-mm diameter, with NewDimium 0.8% doping and convex mirror (S) with 500-mm radius.
A first computer (C1) where chalcographic drawings made with computer graphics software are reprocessed in vector data
A second computer (C2) that receives the vector data from the first computer (C1) through encrypted connection, provided with two electronic boards (S1, S2), respectively used to move the plate or cylinder to be engraved according to two Cartesian axes and to move the head (TS) of the pulsed laser device (L) according to an orthogonal direction to the plane defined by the two Cartesian axes.

6) Installation according to claim 5, characterised by the fact that it comprises a support platform (T) for the plate to be engraved that is actuated by two step by step motors (M1, M2) controlled by the board (S1) of the second computer (C2) with the interposition of suitable power actuators (AP).

7) Installation according to claim 5, characterised by the fact that it comprises a step by step motor (M3) designed to move the head (TS) of the laser device (L) and controlled by the board (S2) of the second computer (C2) with the interposition of a suitable power actuator (AP).

8) Installation according to claim 5, characterised by the fact that the laser device (L) has a pumping diode (D) external to the resonance chamber (R).
